(19) United States
(12) Patent Application Publication
(10) Pub. No.: US 2007/0284188 A1
(43) Pub. Date: Dec. 13, 2007

(54) Evacuation slide having lateral ridges

(76) Inventor: Kathryn Chippindale, Bradford (GB)

Correspondence Address: Galasso & Associates, LP, P.O. Box 26503, Austin, TX, 78755-0503, US

(21) Appl. No.: 11/451,766

(22) Filed: Jun. 13, 2006

(51) Int. Cl. A62B 1/20

(52) U.S. Cl. 182/48

(57) ABSTRACT

An evacuation system designed to be mounted proximate a window of a multi-story building. The evacuation slide includes a storage chamber that has substantially disposed therein an inflator and the evacuation slide in its undeployed condition. The evacuation slide further consists of two main support tubes generally parallel and extending downward with each other when the slide is in its deployed condition. Interposed the main support tubes is a flexible sliding surface. Substantially disposed on the sliding surface is a plurality of speed control ridges that extend upward to control the descent rate of an individual traversing down the evacuation slide.

### FIELD OF THE INVENTION

The present invention relates a device for facilitating evacuation from a facility, and more specifically, but not by way of limitation, to an inflatable evacuation slide that is designed to be mounted externally on a building proximate to an opening, such as a window, that will facilitate a necessary emergency exit of a building in conditions of distress such as a fire.

### BACKGROUND

Thousands of individuals are victims of building fires each year. Unfortunately individuals working or residing in multi-story buildings face a sometimes impossible task when searching for an emergency exit during a fire. Current emergency exit device include various objects such as ladders. However, some individuals trapped in multi-story building fires must wait for rescue personnel to assist them in exiting the building.

One current issue with fire escape methods is that on many occasion rescue personnel are not able to respond to all victims within the necessary time to prevent serious injury or death to that individual trapped in the fire. These individuals often resort to dangerous tactics in an attempt to egress the building such as jumping from a second or third story window. This tactic is extremely dangerous and can result in significant injury to the escapee.

Another issue with current fire escape methods involves the use of ladders. Commonly, rope-style ladders are found on second and above floors for use in exiting the building during a fire. Unfortunately, the ladders can be heavy and awkward to fasten to a window. Physically challenged adults and children have a particular difficult time in deploying and utilizing these rope-style ladders. These ladders can also take several minutes to deploy and properly position which delay a timely emergency exit from a building potentially placing the individual at more risk for injury. Ladders also require several minutes for a person to navigate. Commonly, than one individual must exit the distressed building. Utilizing a rope-style ladder can potentially place individuals waiting to exit the building in a dangerous situation as they have to wait to utilize the ladder due to weight restrictions.

Another challenge with current evacuation systems is the speed of the evacuees' descent. Current devices have failed to include any assistance in controlling the evacuees' descent while traversing the slide. In many instances evacuation devices are at steep angles causing a fast rate of descent which can increase the likelihood injury.

Accordingly, there is a need for a device that will facilitate the emergency exit of individuals trapped in a multi-story building in the event of a fire or other emergency that can be deployed with little effort and is easier to use than current fire safety devices such as but not limited to rope style ladders. The device should further posses the ability to control the rate of descent of the evacuee.

### SUMMARY OF THE INVENTION

It is the object of the present invention to provide a device that facilitates the emergency exit of a plurality of individuals within a relatively short time span from at least the second story of a multi-story building.

It is a further object of the present invention to provide an evacuation slide that is externally mounted proximate the bottom of a window that is on a floor above the ground floor of a building.

Another object of the present invention is to provide an evacuation slide that is externally mounted proximate the bottom of a window on a multi-story building that is automatically inflated by a CO₂ cartridge.

Yet another object of the present invention is to provide an evacuation slide that is manufactured from materials that are resistant to heat.

It is a further object of the present invention to provide an inflatable evacuation slide that has disposed thereon a plurality of ridges to control the descent speed of an individual utilizing the slide.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention deployed and attached to a building;

FIG. 2 is a perspective view of an embodiment of the present invention upon being attached to a building in its undeployed state; and

FIG. 3 is an enlarged detailed view of a portion of the present invention illustrating the speed control ridges substantially disposed on the slide area.

### DETAILED DESCRIPTION

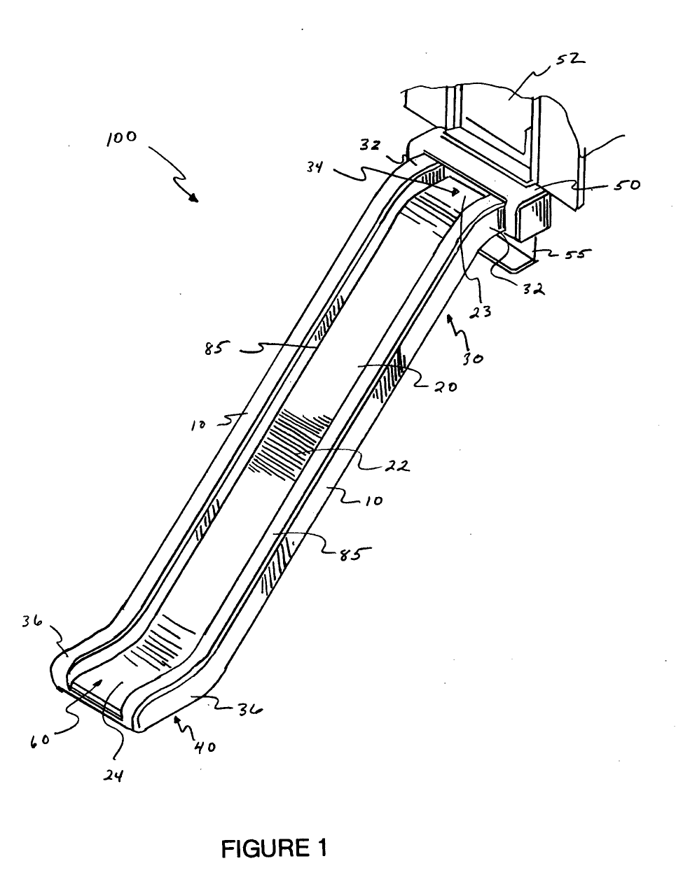

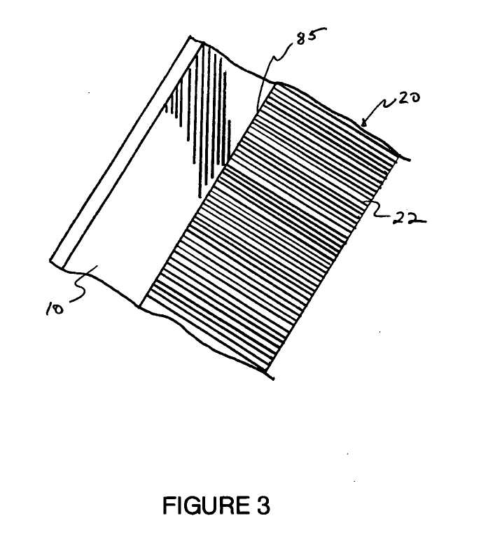

Referring now to the drawings submitted herewith, in particular FIGS. 1, 2 and 3, wherein the various elements depicted therein are not necessarily drawn to scale and wherein like elements are identified with like reference numerals, there is illustrated an inflatable evacuation slide 100 constructed according to the principles of the present invention.

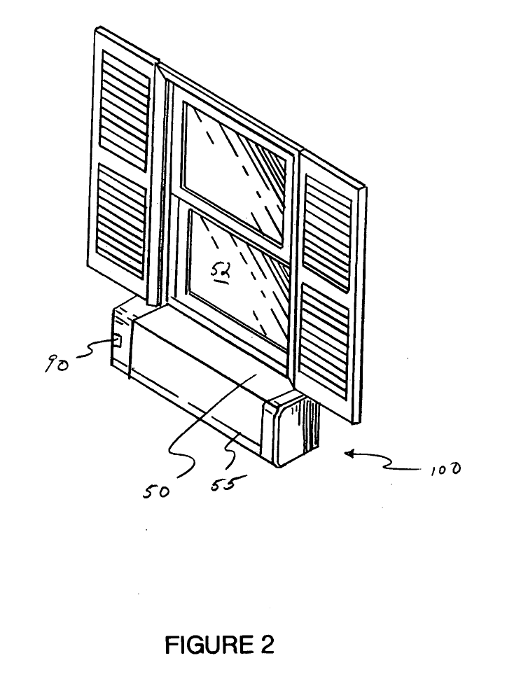

The inflatable evacuation slide 100 is stored in its undeployed condition (see FIG. 2) in a storage chamber 50. The storage chamber 50 is configured in a substantially elongated rectangular manner being substantially hollow and configured to receive therein an inflatable evacuation slide 100 in its undeployed condition. The storage chamber 50 is constructed of a durable rigid material such as but not limited to thermoplastic or metal. It is further contemplated within the scope of the present invention that the storage chamber 50 is manufactured from a material that is weather and temperature resistant.

The storage chamber 50 is mounted proximate the bottom of an opening, such as a window opening on a building at any desired level above the ground floor. The storage chamber 50 is secured by conventional mechanical methods such as but not limited to bolts.

In the preferred embodiment an inflator 90, is utilized to inflate the slide and release it from its undeployed condition as shown in particular in FIG. 2. The inflator is activated by either a conventional ripcord or button and is a conventional pyrotechnic, compressed gas, or hybrid inflating system.

Hingedly attached to the storage chamber 50 distally located from the window 52 is a storage chamber door 55. The storage chamber door 55 is secured by conventional mechanical methods such as but not limited to a piano hinge. When a user activates the inflator 90, the storage chamber door 55 hinges generally away and downward from the storage chamber 50 allowing the inflatable evacuation slide to be deployed from the storage chamber 50. The storage chamber door 55 remains engaged with the storage chamber 50 when the evacuation slide 100 is in its undeployed condition.

Referring in particular to FIG. 1, the inflatable evacuation slide 100 is illustrated in its deployed condition. A pair of main support tubes 10 extend downward toward a horizontal support structure such as the ground. The main support tubes 10 provide the structural support for the inflatable evacuation slide 100. The main support tubes 10 are substantially hollow and rectangular in shape. Upon deployment, the main support tubes 10 are filled compressed gas such as but not limited to CO₂.

The inflated main support tubes 10 are filled with a sufficient pressure that ensures rigid support capable of supporting the load required to assist evacuees down the inflatable evacuation slide 100. Towards the upper end 30 of the inflatable evacuation slide 100 are a pair of parallel upper end main support tubes 32. The upper end main support tubes 32 are contiguously mounted with the main support tubes 10 and are generally angular therewith so as to form a platform 34 at the upper end of the inflatable evacuation slide 100.

The platform 34 is configured in a substantially horizontal manner with respect to the window 52. The platform 34 provides an area for individuals to mount the deployed inflatable evacuation slide 100 in preparation for descent. The upper end main support tubes 32 further function to connect the deployed inflatable evacuation slide 100 to the inside of the storage chamber 50. The upper end main support tubes 32 are fastened by conventional mechanical or chemical methods to the inside of the storage chamber 50.

Distal to the upper end main support tubes 32 contiguously formed with each main support tube 10 are a pair of lower end main support tubes 36. The lower end main support tubes 36 are configured in a substantially parallel manner and generally angle outward from the main support tubes 10 creating a landing area 60 that is substantially parallel with the horizontal support structure in which the lower end 40 is engaged. The landing area 60 functions to receive the individual that has slid down the inflatable evacuation slide 100.

The main support tubes 10, upper end main support tubes 32 and lower end main support tubes 36 are constructed of a durable heat resistant material. It is further contemplated that the material be resistant to punctures. Although no specific material is required, good results have been achieved utilizing a multi-layered material having a middle layer manufactured from a high tenacity basic textile, an upper layer that is manufactured with polyethylene chlorosulfonated material and a bottom layer being manufactured from a polychloroprene material. Each layer has an adhesive layer intermediate therewith the adjacent layer. Those skilled in the art will recognize that numerous different types of material could be utilized in constructing the main support tubes 10, upper end main support tubes 32 and lower end main support tubes 36.

Interposed the main support tubes 10 is a flexible sliding surface 20. The flexible sliding surface 20 is secured on each peripheral edge 85 to the adjacent main support tube 10. The flexible sliding surface 20 is manufactured from a durable material such as but not limited to rubber. It is further contemplated within the scope of the present invention that the flexible sliding surface 20 be manufactured from a material that is heat resistant.

Disposed on a portion of the flexible sliding surface 20 and generally oriented lateral therewith is a plurality of speed control ridges 22. The speed control ridges 22 extend across the flexible sliding surface 20 intermediate the peripheral edges 85. The speed control ridges 22 function to control the rate of descent of an individual traversing down the inflatable evacuation slide 100 by increasing the friction coefficient. The speed control ridges 22 extend upward from the flexible sliding surface 20 and are generally rectangular in shape. Those skilled in the art will recognize that the speed control ridges could be numerous different shapes and perform the function as described herein. Furthermore, it is contemplated that the speed control ridges 22 could be disposed on all or only a portion of the flexible sliding surface 20.

Proximate to the lower end 40 interposed the lower end main support tubes 36 is the lower panel 24 of the flexible sliding surface 20. The lower panel 24 is contiguous with the flexible sliding surface 20 and attached to the lower end main support tubes 36 by conventional mechanical or chemical methods. The lower panel 24 is configured in a substantially parallel manner with a horizontal support structure such as the ground with which the lower end 40 is engaged. Distal to the lower panel 24 proximate the upper end 30 is the upper panel 23. The upper panel 23 is contiguously mounted to the flexible sliding surface 20 and is intermediate the upper end main support tubes 32 being secured by conventional mechanical or chemical methods as is known in the art. The upper panel 23 is configured in substantially a perpendicular manner with the adjacent window 52 and functions to define a portion of the platform 34.

Now referring in particular to FIG. 1, a description of the operation of the present invention is as follows. In use, the undeployed inflatable evacuation slide 100 is installed adjacent to and generally underneath a desired window 52 on a floor that is above the ground floor. The storage chamber 50 is bolted to the exterior of the building. Upon the need for an emergency exit from the building, a user will open the window 52 and activate the inflator 90 which will facilitate the opening of the storage chamber door 55 and cause the main support tubes to inflate with a pressurized gas thereby extending the inflatable evacuation slide 100 in a downward direction towards a suitable horizontal support structure such as but not limited to the ground. Once in its deployed condition, the user will then board the inflatable evacuation slide 100 proximate the platform 34 and proceed to slide down the flexible sliding surface 20. The user's descent rate is reduced by the plurality of speed control ridges 22 that are laterally disposed across the flexible sliding surface 20. The user then comes to rest proximate the lower end 40 and dismounts the inflatable evacuation slide 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An evacuation device configured to transport a user from a first level to a second level, comprising:
an inflatable slide, said inflatable slide configurable in an undeployed state when said inflatable slide is uninflated and in a deployed state when said inflatable slide is inflated;
a storage chamber, said storage chamber configured to contain said inflatable slide when said inflatable slide is in the undeployed state;
said inflatable slide including a flexible sliding surface, said flexible sliding surface extending from the first level to the second level when said inflatable slide is in the deployed state; and
said inflatable slide including first and second main support tubes, each of said first and second main support tubes being configured generally parallel to each other with said flexible sliding surface interposed therebetween.

2. The evacuation device as recited in claim 1, and further including an inflator, said inflator operable to inflate said inflatable slide such that said inflatable slide transistions from the undeployed state to the deployed state.

3. The evacuation device as recited in claim 2, and further including a plurality of speed control ridges, said speed control ridges extending across at least a portion of said flexible sliding surface, said speed control ridges operate to limit the rate of descent of an individual descending on said flexible sliding surface.

4. The evacuation device as recited in claim 3, wherein said storage chamber further includes a door, said door being hingedly mounted to said chamber, said door operable between a first position and a second position, such that said door is in said first position when said inflatable slide is in the undeployed state, and said door is in said second position when said inflatable slide is in the deployed state.

5. The evacuation device as recited in claim 4, wherein said inflatable slide includes a platform configured to receive a user.

6. The evacuation device as recited in claim 5, wherein said inflatable slide includes a landing area.

7. The evacuation device as recited in claim 6, wherein said flexible sliding surface is manufactured from rubber.

8. An evacuation device configured to be mounted under a window of a building and operable to be extend downward towards a suitable support structure, comprising:
an inflatable slide, said inflatable slide configurable in an undeployed condition when said inflatable slide is uninflated and in a deployed condition when said inflatable slide is inflated;
a storage chamber, said storage chamber connected proximate the window, said storage chamber being configured to receive therein said inflatable slide when said inflatable slide is in said undeployed state;
two support tubes, each of said two support tubes being configured generally parallel to each other and extending downward towards the suitable support structure when said inflatable slide is in said deployed condition; and
a flexible sliding surface, said flexible slide having a first peripheral edge and a second peripheral edge, said flexible sliding surface interposed each of said two support tubes, said flexible sliding surface being connected to said support tubes proximate said first peripheral edge and said second peripheral edge.

9. The evacuation device as recited in claim 8, and further including an inflator, said inflator operable to transition said inflatable slide from its undeployed condition to its deployed condition.

10. The evacuation device as recited in claim 9, and further including a plurality of speed control ridges, said speed control ridges being substantially disposed on said flexible sliding surface, said speed control ridges for controlling the descent rate of an individual traversing down said flexible sliding surface.

11. The evacuation device as recited in claim 10, wherein said evacuation slide has an upper end and a lower end, said upper end being proximate said window on said building, said lower end being proximate said suitable horizontal support structure.

12. The evacuation device as recited in claim 11, and further including a platform, said platform being proximate said upper end of said evacuation slide, said platform being generally perpendicular to said window.

13. The evacuation device as recited in claim 12, and further including a landing area, said landing area being proximate said lower end of said evacuation slide, said landing area being generally parallel with said horizontal support structure.

14. The evacuation device as recited in claim 13, wherein said inflator is a compressed gas inflator.

15. An evacuation system configured to be mounted under a window of a multi-story building and extend in a deployed condition downward towards a suitable horizontal support structure comprising:
a storage chamber, said storage chamber proximate said window, said storage chamber being generally rectangular in shape and hollow, said storage chamber having disposed therein an inflatable evacuation slide in an undeployed condition, said storage chamber further including a door having a first position and a second position;
an upper end, said upper end of said evacuation slide being proximate said storage chamber;
a lower end, said lower end being proximate said suitable horizontal support structure;
two main support tubes, said support tubes being configured generally parallel to each other and extending downward towards a suitable horizontal support structure when said evacuation slide is in its deployed condition, said main support tubes being substantially rectangular and hollow in shape, said main support tubes further being configured to receive therein a compressed gas;
a flexible sliding surface, said flexible slide having a first peripheral edge and a second peripheral edge, said flexible sliding surface interposed said main support tubes, said flexible sliding surface being connected to said main support tubes proximate said first peripheral edge and said second peripheral edge;
a plurality of speed control ridges, said speed control ridges being substantially disposed on said flexible sliding surface, said speed control ridges being positioned laterally across said flexible sliding surface, said speed control ridges extending upward from said flexible sliding surface; and
an inflator, said inflator being substantially disposed within said storage chamber, said inflator configured to transition said evacuation slide from its undeployed condition to its deployed condition.

16. The evacuation system as recited in claim 15, and further including a platform, said platform being proximate said upper end of said evacuation slide, said platform being generally perpendicular to said window.

17. The evacuation system as recited in claim 16, and further including a landing area, said landing area being proximate said lower end of said evacuation slide, said landing area being generally parallel with said horizontal support structure.

18. The evacuation system as recited in claim 17, wherein said inflator is a compressed gas inflator.

19. The evacuation system as recited in claim 18, wherein said flexible sliding surface is manufactured from rubber.

20. The evacuation system as recited in claim 18, wherein said inflator is a carbon dioxide inflator.
